(19) United States
(12) Patent Application Publication
(10) Pub. No.: US 2004/0104893 A1
(43) Pub. Date: Jun. 3, 2004

(54) Interactive keyboard

(76) Inventor: Kuang-Yu Huang, Taipei Hsien (TW)

Correspondence Address: WILDMAN, HARROLD, ALLEN & DIXON, 225 WEST WACKER DRIVE, CHICAGO, IL, 60606, US

(21) Appl. No.: 10/307,713

(22) Filed: Dec. 2, 2002

(51) Int. Cl. G09G 5/00

(52) U.S. Cl. 345/168

(57) ABSTRACT

The disclosed interactive keyboard includes a key matrix, a microprocessor, and a memory unit. A keyboard key management driver is enabled to download the key codes for the application software or to set a key code to a designated key as defined by the user. The user can thus selectively perform specific commands in the application software from keys on the keyboard, speeding up the operations in the application software.

### BACKGROUND OF THE INVENTION

1. Field of Invention

The invention relates to an interactive keyboard and, more particularly, to an interactive keyboard with the function of programmable keys and the method thereof.

2. Related Art

Personal computers (PCs) become popular electronics in businesses and families to help users to process word documents and numerical data. The keyboard is a primary input peripheral device of the PC. It provides the data input of characters, numbers, and other functions through programmed keys.

The conventional keyboard design unidirectional sent out the key codes . The computer software or operating system (OS) then makes the corresponding actions according to the received key code. As all the keys on the keyboard have their own fixed key codes, the user is not able to change them. Therefore, the functions of the keys are limited to whatever is provided. However, software nowadays becomes so sophisticated that the keyboard with one-way key codes will be out of fashion.

Furthermore, in order for its user to quickly perform a particular command, a conventional applications operating interface usually allows to program hot keys. For example, when the user runs Microsoft Word under the Windows OS, the user can use “Ctrl+N” to open a new file, “Ctrl+O” to open an old file. In additional, similar built-in functions are also provided for Microsoft Excel.

However, when using hot key functions of the application software, the user has two ways to perform a particular command. One is to use the mouse to click the function table on the window and pull down a menu, from which the user finds a desired command to select. The other method is to directly press the corresponding hot key for the command. For example, holding the “Ctrl” key and then pressing the “N” key do the hot key “Ctrl+N”.

According to the prior art, the method using the mouse to click the menu and perform a command requires the user to press the mouse and often to go through several steps before finding the desired command. The method of using hot keys requires the user to remember all sorts of different combinations for functions in different software. If the key combination is set on a single hot key, it may not be applicable to all software because of different hot key definitions. Although the Windows OS defines some unanimous key combinations, there are still many other key combinations that are not completely agreed upon by different utilities. Moreover, the user can define a desired key combination and non-Microsoft software usually has different key combinations. Therefore, the normal keyboard design cannot satisfy such needs.

Many medical reports have provided warnings about of damage to human bodies due to overuse of the mouse. Therefore, inventing a convenient key operation interface to reduce the mouse use is good for human health. The invention provides an interactive keyboard. Through a keyboard hot key management driver, responding to the download of hot key codes for various application software or associate a hot key code to a hot key on the keyboard according to the user's setting. Consequently, the disclosed interactive keyboard can selectively associate the hot keys on the keyboard with certain commands in the running utility for the user to conveniently operate the application software.

### SUMMARY OF THE INVENTION

A primary objective of the invention is to provide an interactive keyboard with the function of programmable keys. Through a keyboard key management driver running on a PC, the disclosed keyboard downloads the key codes required by various application programs or associate the hot keys on the keyboard with certain commands in the running program. Therefore, the user can quickly perform functions of the program by pressing the hot keys.

Another objective of the invention is to provide an interactive keyboard with the function of programmable keys , through a keyboard key management driver running on a PC, detecting the application program the user is running and download the hot key table of the utility to the memory unit.

As seen in the prior art, both the methods of using a mouse to select a command in the application software window and using a key combination to perform a hot key command cannot effectively perform the commands of application software. The invention provides an interactive keyboard that can download hot key codes to designated hot keys according to the application software performed by users.

According to a preferred embodiment of the invention, the interactive keyboard comprising: a key matrix, a memory unit, and a microprocessor. The key matrix contains standard keys and hot keys. The memory unit stores the key codes of the hot keys. The microprocessor scans the key status of the key matrix and, in response to the key status of the hot keys, reads the key codes of the hot keys output from the memory unit. Moreover, the interactive keyboard of the invention further contains an I/O interface as the link between the computer system and the keyboard. The I/O interface is electrically connecting the microprocessor. The OS runs a keyboard management driver to download the key codes needed for each of the application software or to associate a key code to a key on the keyboard according to the user's setting. The keyboard management driver further sends out the key status of the key matrix output from the microprocessor to a PC host.

### BRIEF DESCRIPTION OF THE DRAWINGS

The present invention will become more fully understood from the detailed description given hereinbelow illustration only, and thus are not limitative of the present invention, and wherein:

FIG. 1 is a top view of the case configuration of the disclosed interactive keyboard;

FIG. 2 is a block diagram of the disclosed interactive keyboard connecting to a computer system;

FIG. 3 is a flowchart for the microprocessor of the disclosed interactive keyboard;

FIG. 4 is a download flowchart of the disclosed keyboard hot key management driver; and

FIG. 5 is a table-building flowchart of the disclosed keyboard hot key management driver.

### DETAILED DESCRIPTION OF THE INVENTION

The invention provides an interactive keyboard. By running a keyboard key management driver, key codes for application software are downloaded or set by the user to keys on the keyboard. Therefore, the user can use the disclosed interactive keyboard to selectively and quickly perform particular commands in the application software from the keys on the keyboard.

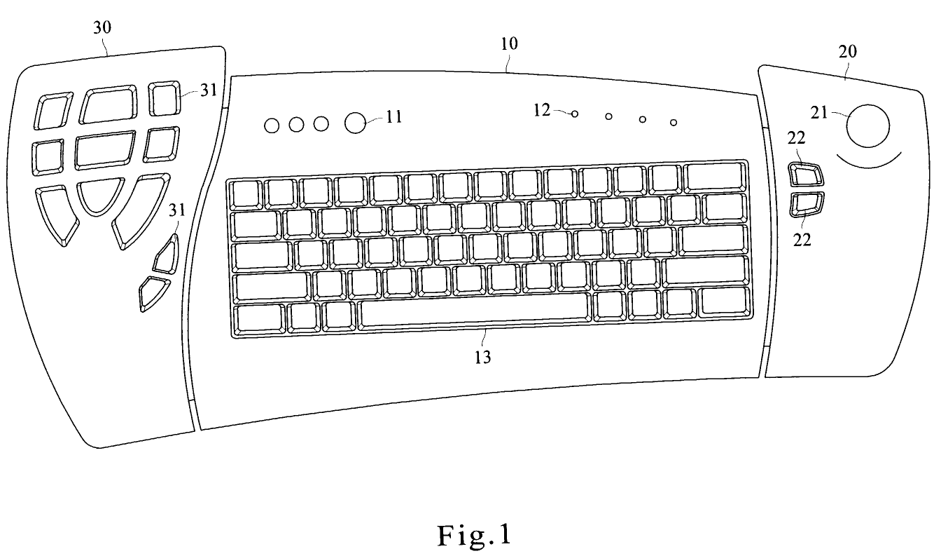

With reference to FIG. 1, the case configuration of the interactive keyboard of the invention comprising: a body 10, a right portion 20, and a left portion 30. The body 10 is provided with standard keys 13 containing a plurality of character keys, a plurality of number keys, and a plurality of cursor control keys. The right portion 20 is connected to the right side of the body 10. It is provided with a direction control mechanism 21 and a plurality of mouse keys 22. The left portion 30 is connected to the left side of the body 10. It is provided with a plurality of hot keys and interactive keys.

In an embodiment of the invention, the normal keyboard can be modified and become an interactive keyboard. For example, the function keys F1˜F12 on the normal keyboard can be changed to interactive keys. The function keys F1˜F12 can then be used as combination keys or multimedia keys. Of course, one can choose to keep the original functions of F1˜F12. In this case, the invention can upgrade the normal keyboard to an interactive keyboard without changing any devices or modules.

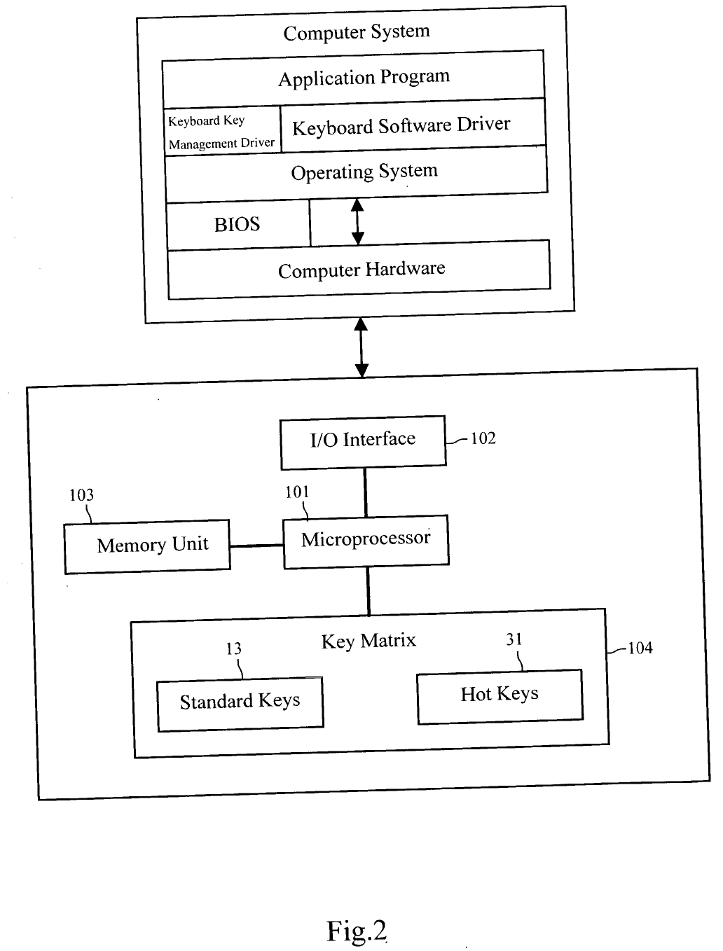

With simultaneous reference to FIGS. 1 and 2, a preferred embodiment of the disclosed interactive keyboard is connected to a computer system. The interactive keyboard comprising: a key matrix 104, a memory unit 103, and a microprocessor 101. The key matrix 104 contains the standard keys 13 and a plurality of hot keys 31. The standard keys 13 have their fixed key codes. The hot keys 31 have programmable functions. Their key codes can be downloaded according to one application software. Alternatively, a key code combination can be assigned to a single hot key 31. The memory unit 103 stores the key codes for the keys in the key matrix. Pursuant to the programmable key code function, the key codes of the hot keys 31 can be repeatedly accessed in the memory unit 103. The microprocessor 101 scans the key status of the key matrix 104 and, in response to the key status of the hot keys 31, reads the key codes of the hot keys 31 output from the memory unit 103. The key status refers to the pressed or released state of a hot key 31. When the computer system runs a keyboard key management driver, the driver downloads key codes of the hot keys 31 via the I/O interface of the computer system. Processed by the microprocessor 101, the key codes are stored in the memory unit 103. The key codes of standard keys 13 can be stored in the read-only fashion in the memory unit 103.

The disclosed interactive keyboard further comprising: an I/O interface 102 as the link between the computer system and the keyboard. The I/O interface 102 is electrically connecting the microprocessor 101. When the OS runs a keyboard key management driver, each hot key code preset by the utility or defined by the user is download to the memory unit 103 of the keyboard. The key codes output from the microprocessor 101 after scanning the key status of the key matrix 104 are transmitted to the computer system via the I/O interface 102.

Please refer to FIG. 2 again. The computer system connected with the disclosed interactive keyboard runs an OS, such as Windows 98 or Windows XP, and is installed with a keyboard software driver. The keyboard software driver includes a keyboard key management driver. When the user wants to perform the application software, the keyboard key management driver downloads the hot key codes provided by the utility or defined by the user. Through the I/O interface 102 of the keyboard, the microprocessor 101 stores the hot key codes to the memory unit 103. The microprocessor 101 further scans the key status of the key matrix 104 and outputs the downloaded key codes corresponding to the key status of the hot keys 31. The key codes output from the microprocessor 101 are transmitted to the computer system via the I/O interface 103, requesting the application software to perform a particular function.

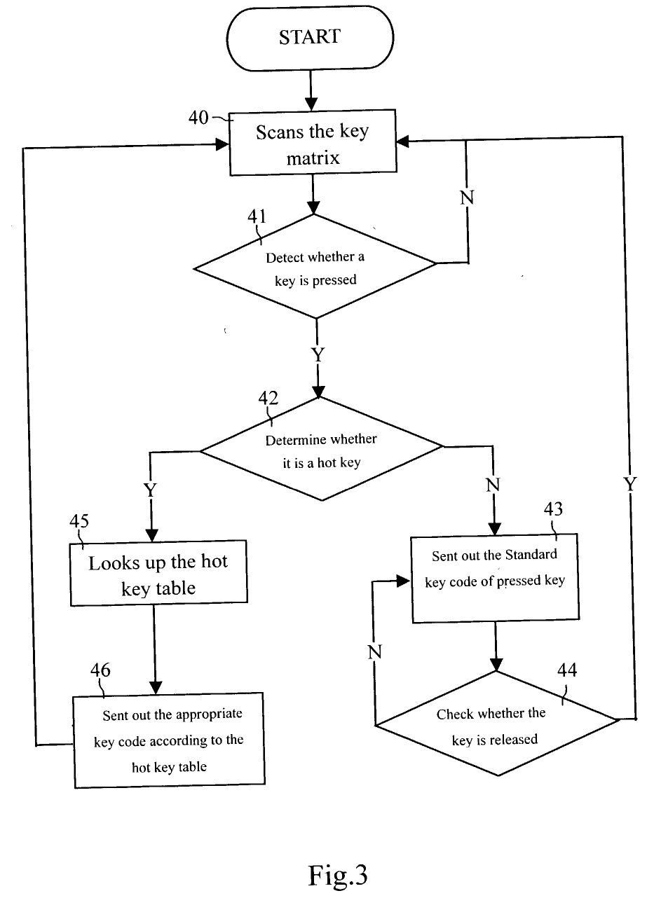

Please refer to FIG. 3 along with FIG. 2. The microprocessor 101 implemented in the disclosed interactive keyboard is a universal program controller with input signal pins and output signal pins. The microprocessor 101 scans the key status of the key matrix 104 to obtain the pressing status of each of the keys 13, 31. The microprocessor 101 performs the following procedures. First, it scans the key matrix (step 40). In this step, the microprocessor 101 first scans the key status of the key matrix 104 to detect whether a key is pressed (step 41). If no key is pressed, the key status of the key matrix is checked and scanned. Once a key is detected for to be pressed, then the microprocessor determines whether it is a hot key (step 42). If it is not a hot key, then the standard key code of the pressed key is sent out (step 43). The microprocessor 101 then detects whether the key is released (step 44). If the pressed key is released, then the procedure goes back to step 40 to continuously scan the key status of the key matrix 104; otherwise, the standard key code is continuously sent out. If the pressed key is detected to be a hot key, then the microprocessor 101 reads the memory unit 103 and looks up the hot key table (step 45). An appropriate key code according to the hot key table recorded in the memory unit 103 is sent out (step 46). The microprocessor 101 then transfers the key code to the computer system via the I/O interface 102. Afterwards, the procedure goes back to step 40 for continuously scanning the key status of the key matrix 104.

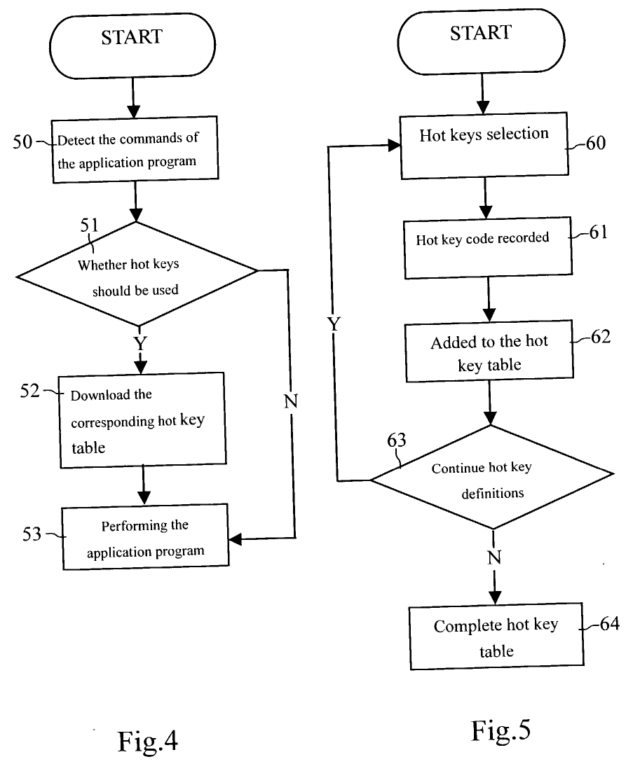

With reference to FIG. 4, in an embodiment of the invention when the OS is running a keyboard key management driver, the download procedure of the driver comprising the following steps: First, when a user wants to start an application program, the OS detects the commands of the application program (step 50). In response to the commands, the OS asks the user whether hot keys should be used (step 51). For example, an inquiry window is prompted on the computer monitor for the user to select. If the user selects to use hot keys, then the keyboard key management driver downloads a hot key table to the microprocessor 101 via the I/O interface 102 of the keyboard (step 52) and stores it in the memory unit 103. The downloaded hot key table is a hot key table preset in the computer system or defined by the user. After the application program is performed (step 53), the user can use the hot keys 31 to quickly operate the application program. If the user selects not to use the hot keys (step 51), then the user directly uses standard keys to manipulate the operations of the application program (step 53).

We describe here another embodiment of the download procedure of the disclosed keyboard hot key management driver. When a user wants to start a application program, the OS will detect the command to perform the application program (step 50). The keyboard key management driver automatically detects the application program currently being performed, selects and downloads the corresponding hot key table (step 52). The downloaded hot key table is stored to the memory unit 103 of the keyboard. The difference between the current embodiment and the previous one is that it automatically downloads the hot key table according to the software without asking the user.

With reference to FIG. 5, the table-building procedure of the keyboard hot key management driver can record key codes on designated hot keys according to the user's requirements. For example, when the user wants to define one of the hot keys 31 on the left portion 30 on the interactive keyboard case in FIG. 1, the table-building procedure comprising the follows steps: First, one of the hot keys is selected according to the user's requirement (step 60). The hot key code is recorded for the designated hot key (step 61) and added to the hot key table (step 62). The procedure then detect whether the user wants to continue hot key definitions (step 63). If the user wants to continue, then the user selects another key in the hot keys for recording the key code (step 61). If the user does not want to continue with hot key definitions, then the procedure ends.

Please continue referring to FIG. 5 along with FIG. 1. In an embodiment of the invention, the recorded key code in step 61 of the table-building procedure may be a key combination code or a code of continuous key entry for a application program. In another embodiment of the invention, the method of recording key codes includes macro-editing software that record key codes according to the user's requests. The macrocode is then assigned with the key code of one of the designated hot keys in the hot key table.

In addition, in a varied embodiment of the invention, an undefined key code can be used to communicate with a program. Therefore, all interactive keys can be used as special function keys to control the program. For example, there may be key codes for linking to a particular website or running a specific application program. According to personal needs, the key code can be assigned to a hot key to expand the functions of the keyboard and the OS.

Most of the multimedia keyboards have been defined with multimedia, shutdown or other function keys. If the user does not need to use them or does not like those functions, it would be troublesome if the function keys cannot be removed or redefined. For example, some keyboards are provided with shutdown keys. The user may remove the key because of the worry about incorrect hits or of using the computer as a display. This renders an ugly-looking keyboard. According to the invention, one only needs to run a key management driver in the OS to redefine the key codes of the function keys on the interactive keyboard. Therefore is no need to change the hardware.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An interactive keyboard is electrically connecting a computer system, comprising:
an I/O interface, which is connected to the computer system;
a key matrix, which includes standard keys and a plurality of hot keys;
a memory unit, which is able to repeatedly access key codes of said hot keys; and
a microprocessor, which is connected to said I/O interface, receives key codes downloaded from the computer system, stores the key codes to the memory unit, reads, in response to the key status of a hot key, from the memory unit the key code corresponding to the hot key, and outputs the key code to the computer system.

2. The interactive keyboard of claim 1, wherein said computer system performs a hot key management driver.

3. The interactive keyboard of claim 2, wherein said hot key management driver downloads the key codes to the microprocessor.

4. The interactive keyboard of claim 1, wherein said key status is the pressed and released states of the hot keys.

5. The interactive keyboard of claim 1, wherein said standard keys includes a plurality of character keys, a plurality of number keys and a plurality of cursor control keys.

6. An interactive keyboard connected to a computer system, comprising:
a key matrix, which includes a first portion keys and a second portion keys, the key codes of the first portion keys being fixed while the key codes of the second portion keys being downloaded from the computer system; and
a microprocessor, which is electrically connecting the computer system for receiving the key codes downloaded from the computer system, and outputs the key code corresponding to the status of the second portion keys to the computer system.

7. The interactive keyboard of claim 6 further includes an I/O interface connected with the computer system for the microprocessor to transmit data to the computer system and receive data from the computer system.

8. The interactive keyboard of claim 6 further comprising a memory unit for repeatedly accessing the key codes of the second portion keys.

9. The interactive keyboard of claim 6, wherein said first portion keys includes standard keys comprising a plurality of character keys, a plurality of number keys, and a plurality of cursor control keys.

10. The interactive keyboard of claim 6, wherein said computer system performs a hot key management driver.

11. The interactive keyboard of claim 10, wherein said hot key management driver downloads the key codes to said microprocessor.

12. A download method for an interactive keyboard, comprising the steps of:
detecting the command for performing a application program; and
downloading and storing a hot key table to a memory unit of a keyboard for repeatedly accesses.

13. The download method of claim 12, wherein said step of detecting the command for performing a application program is followed by the step of asking the user whether the hot key table should be downloaded.

14. The download method of claim 13, wherein the hot key table includes a plurality of key codes corresponding to the plurality of keys on the keyboard.

15. A key code management method for an interactive keyboard, comprising the steps of:
establishing a hot key table; and
downloading the hot key table to a memory unit of a keyboard for repeatedly accesses.

16. The key code management method of claim 15, wherein said step of establishing a hot key table includes the step of assigning a hot key on the keyboard.

17. The key code management method of claim 16, wherein said step of hot key assignment includes the step of recording the key code of the hot key.

18. The key code management method of claim 16, wherein said key code is a code of a key combination.

19. The key code management method of claim 16, wherein said key code is a continuous key input operation.

20. The key code management method of claim 16, wherein said key code is for linking to a particular website.

21. The key code management method of claim 16, wherein said key code is a macro-edited key code.

22. The key code management method of claim 15, wherein said step of downloading includes the step of detecting the command for performing a application program.

23. The key code management method of claim 15, wherein said step of downloading includes the step of asking the user whether the hot keys should be downloaded.

24. The key code management method of claim 15, wherein said hot key table includes a plurality of key codes corresponding to the plurality of keys on the keyboard.
